(19) United States
(12) Patent Application Publication
(10) Pub. No.: US 2014/0344015 A1
(43) Pub. Date: Nov. 20, 2014

(54) SYSTEMS AND METHODS ENABLING CONSUMERS TO CONTROL AND MONETIZE THEIR PERSONAL DATA

(71) Applicants: José Antonio Puértolas-Montañés, Madrid (ES); Alfredo Láinez-Rodrigo, Alcala de Henares (ES)

(72) Inventors: José Antonio Puértolas-Montañés, Madrid (ES); Alfredo Láinez-Rodrigo, Alcala de Henares (ES)

(21) Appl. No.: 14/283,169

(22) Filed: May 20, 2014

Related U.S. Application Data
(60) Provisional application No. 61/825,500, filed on May 20, 2013.

(51) Int. Cl. G06Q 20/10; G06Q 30/02

(52) U.S. Cl. CPC G06Q 20/10; G06Q 30/0201
USPC 705/7.29

(57) ABSTRACT

The present invention relates to systems and methods for providing personal computing and service provider platforms for enabling a consumer to control and monetize their personal data while managing their online privacy. Business methods utilizing the systems and methods of the present invention resemble those of profit-sharing and asset-sharing paradigms such as cooperatives, and they comprise means for enabling a diverse array of individual subscriber shareholders to receive dividends, share profits and assets, pool resources, and otherwise participate in the ownership of the personal and behavioral data and other content that they generate.

### CROSS-REFERENCE TO RELATED APPLICATIONS

This application claims the priority benefits of U.S. Provisional Application No. 61/825,500 to Puèrtolas-Montañès et al., filed on May 20, 2013, according to 35 U.S.C. §119(e), which application is hereby incorporated by reference in its entirety for all purposes.

### BACKGROUND OF THE INVENTION

1. Field of the Invention

The present invention relates to systems and methods for securing privacy and for monetizing personal information and content of consumers using the internet. In particular, the invention discloses means for providing personal computing hardware and software within a networked service provider platform which enables individuals to regulate and profit from the use of their personal and behavioral data. Business methods utilizing the systems of the present invention resemble those of mutual companies, cooperatives, or other profit-sharing and as set-sharing paradigms, in that they pay dividends, share profits and ownership of assets, and pool resources.

2. Description of the Related Art

The following review of related art is intended to provide edifying examples of problems and pitfalls in the design and use of online privacy and content monetization systems, including systems and methods for collecting, managing, and trading personal and behavioral data. The mention of these examples does not constitute an admission that any of the following methods or devices constitute prior art applicable to the present invention. The discussion of the references states what their authors assert, and the applicant reserves the right to challenge the accuracy and pertinency of any of the documents cited herein.

Whenever consumers navigate and interact online, third parties collect information about their identities and activities. Personal and behavioral data are profitable to third parties whose businesses rely upon providing targeted advertisements, content, goods and services to individuals. Said date can also be useful to businesses who harvest “free” information, customer contact data (e.g., “leads”), and original content from the public domain, from careless members of the internet community who expose their local hardware to security breaches, and from subscriber services in various digital forums. In some ways, the application of personal and behavioral data to the commercial activity of third parties can enhance the value of consumers' web surfing, shopping, and other experiences by facilitating the presentation of advertisements, news, and other content that agree with a consumer's known preferences. However, this benefit is only achieved when the data are accurate, when the data are powerful enough to provide predictive value, and when the parties are using (and creating) the data for honest, mutually beneficial aims.

A prevalent means for collecting such data is “behavioral tracking,” which is a field comprising various systems and methods for monitoring and tracking individuals in cyberspace (and to a lesser extent in the real world) for the purpose of compiling a profile for each individual, where such systems and methods are well described and understood by persons of ordinary skill in the respective arts. What little regulation exists over these systems and methods, including rules about how information may be collected and used, is somewhat provided by consumer protection and privacy laws, although in reality the regime is largely controlled by the companies that perform the bulk of it according to the promptings of their financial interests, which amount to an industry aggregate of many billions of dollars per year. This status quo offers almost no leverage to the individual consumer who is ironically both the producer and an end-user of his or her own personal-behavioral data. Gary Kovacs, the CEO of Mozilla Corp., developed a program called “Collusion” to assess the extent of internet monitoring that occurs without a consumer's direct knowledge and found it to be humungous, commenting that “with every click of the mouse and every touch of the screen we are like Hansel and Gretel, leaving breadcrumbs of our personal information everywhere we travel through the digital woods.”

Commercially valuable or useful data and content relating to individuals are not only found as footprints in cyberspace, but are also buried like treasure within the memory of electronic devices and their individual internal components. Data can be harvested as they arise in real time or retrospectively whenever it is possible for third parties to ingress into various sectors and files on consumer devices (and when collated as metadata). Third parties have developed battalions of automated and embedded applications that can hunt, track, and gather relevant data and content from inside and/or outside the computers, devices, and applications all consumers use. Deep-pocketed aggregators negotiate with big-name digital device and software manufacturers to allow them to eavesdrop or raid data on consumer's privately owned devices without the informed consent of the consumers and without any real chance for consumers to opt-out. For example, Apple, Inc., notoriously failed to inform its first-generation iPhone customers that it was tracking their location and activity at all times and providing that information to third parties, particularly advertisers. No one has any incentive to resist the data mongering industry in the systems of the status quo, but a structural paradigm shift must occur in the internet value chain if consumers hope to obtain any leverage against these interlopers.

Because individuals do not participate knowingly and directly in the collection and management of their personal-behavioral data, but rather the data are compiled from piecemeal and indirect methods by the offending third party agents, the resulting data are inherently inaccurate and undervalued when obtained by third parties using the systems and methods of the prior art. This scenario is a drag on the efficiency of the marketplace that impedes the objectives of the data buyers whose demand is driven by the accuracy of the data. The present invention contemplates that in order to derive the maximum value from personal behavioral data, individuals being tracked should participate, provide feedback, and otherwise help to regulate, manage, organize, and use their own personal-behavioral data, and combine it with the voluntary submission of additional data.

The present invention provides effective solutions to these challenges and unmet needs in the art, but it goes much farther too by integrating them with an economic framework for commoditizing and marketing these data competitively against the same players causing privacy and unfairness issues for consumers now. And the present invention goes still farther beyond the prior art to provide business methods, complete with means for sharing assets and profits according to corporate laws and practices well known in the art of commercial business management, yielding an integrated and inherently profit-driven, efficient system that maximizes the incentives of consumers to subscribe to the system of the present invention and to strive to enhance its efficiency and effectiveness.

As individuals (whether consumers, business, organizations, or other entities) exert time and effort to behave and create content online, whenever they voluntarily read and post, sort and seek, organize and share, perform and inform, and otherwise interact with content in the digital world, a quantum meruit is generated that presently does not and cannot be realized by the originators because there are no means in place within the infrastructure of the digital world to enable or enforce said individuals' ownership rights in the data they generate through their labor, especially when it is generated indirectly or unwittingly. Instead, third parties reap and horde personal-behavioral data and useful file content from consumer devices and software for their own enrichment, often demanding that the individuals who generated it pay these data thieves in order to have any share in its use, if they extend them any such option to participate at all. The above facts represent a serious economic inefficiency whose remedy requires Invention.

### SUMMARY OF THE INVENTION

The present invention satisfies the above needs. At its most abstract level, the present invention establishes a four-pillar framework for operating a business model that oversees a networked platform that provides goods and services to subscribers by capturing, apportioning, and regulating personal data, as well as by offering interactive tools for managing the creation, organization, distribution and monetization of personal data from within and across any and all of a subscriber's devices, assets, and cyberspace locales. Said goods and services generally comprise hardware and software establishing a virtual community network riding on top of the internet, but which also include discrete hardware and software that integrate with commercially available consumer goods (or that replace them with competing alternatives), wherein the goods and services of the present invention insert or impose a series of proxies, gateways, and aggregators between the consumer and those who seek to track them and obtain their personal data, or those who may desire to profit from said personal data.

In general, the present invention enables the ownership, management, and monetization (i.e. profitability) of subscriber-generated data to be profitably shared by the community of subscribers. Subscribers' are shareholders or mutual owners of the community. Their interests are represented by an administrating entity that implements the system of the invention. A subscriber implements means for regulating privacy via gateways, which often involve the use of proxies, and other tools for participating in the data management, input, and output of devices and programs used by consumers within a community of subscribers. In preferred embodiments, said subscriber is given a share in ownership of stock or assets and is therefore incentivized by compensation for his or her contributions of labor and original content in accordance with the strategic and financial objectives of the system to produce better and more valuable data, while simultaneously benefiting from enhanced privacy privacy protection which the systems also provide by virtue of their monitoring and sequestering personal data.

Gateways and aggregators are general terms for any computer-implemented means for using hardware and/or software, resident on a particular end-user's computer device and/or on a remote device such as a server, to monitor and regulate the exchange of data, either generally or specifically, as the data move from the individual subscribers to the public domain, or vice versa. Privacy sealing mechanisms are imposed within or in conjunction with these mechanisms to protect against foreseeable risks and to protect certain data in optimal ways. Applications providing the above benefits may be interposed anywhere in the network(s) on which subscribers in a community operate, by any appropriate means known in the art, such as through cookies, plug-ins, background applications, desktop applications, operating systems, hardware architecture, software patches, proxies, means for encrypting and anonymizing data, means for watermarking or embedding or tagging digital content, stand-alone products and services, including assistance from both human and automated agents, and by legal or contractual means negotiated between relevant parties through licenses, partnerships, joint ventures, and other agreements. When residing in the public domain or on the server-side of the information barriers that lie between an individual subscriber and the world, said gateways and aggregators may be installed at any suitable node or machine location where a given member's personal-behavioral data are in play. The administrating entity of the system of the present invention administers the most powerful and extensive goods and services by which its intended goals are achieved but shares the ownership and value of said data with each individual subscriber according to that which each subscriber provides, according to informed consent and terms of use ratified by said subscribers and established by the management arm of the business methods of the system in compliance with applicable business laws and regulations, the company's bylaws, and its executive officers, for example. Preferably, all software and operations-related content are developed in-house for use exclusively in system of the present invention, but in most implementations it is viable and may be more cost-effective to import modular applications or commercial products to accomplish some of the many desirable functions, which can be implemented by the present invention, as the circumstances of any consumer may warrant.

Essentially, the implementation of the present invention alters the very structure of the traditional internet value chain. It achieves this result primarily, but not exclusively, by utilizing the above elements to create one or more barriers (and thus one or more costs) to the acquisition and use by third parties of subscribers' personal-behavioral data and original content. Behind these barriers, the data acquire money value proportional to said costs, which value is retained by and/or returned to the subscribers.

Therefore, it is a first objective of the present invention to provide an integrated system comprising means for enabling a consumer to control and monetize their personal data, both as it is generated by their activity and as it is stored in the memory of a computer device, which thereby improves the privacy of the individual consumer and of their data while simultaneously enabling said consumer to capitalize on the monetary value inherent in said personal data and on stored content. A principal method for sharing revenue with consumers who are users of the systems of the invention is via the distribution of revenue according to equity shares or cooperative schemes whereby the quality and quantity of activities of the individual consumers, and/or the characteristics of their subscriptions and services on the system, determine what value they receive in exchange for their decisions to monetize certain data. A variety of profit sharing, shareholding, and remuneration schemes are provided according to a schedule of terms that can be specified by an administrator of any Community of members (i.e., subscribing consumers) of any implementation of the invention. Mixed methods may be employed also, whereby some forms of content can be monetized on a per-use basis, others on a royalty basis, and others on an equity or dividend basis, and so on.

It is another objective of the present invention to provide a “data sealer” comprising means for ensuring the anonymity of users and their data, facilitating the private and secure monetization of said data via a User Broker Engine. This is useful for the consumer who wishes to profit from their personal behavioral data, but to withhold some of it, such as name, address, phone number, or any other particular data item. This type of selective data sharing is not possible in the prior art, but is enabled by the data sealer application, which acts like a selective privacy filter that is also transparent and controllable by the consumer. Another advantageous application within the software of the system, the User Broker Engine technology, may comprise both hardware and software in order to mediate input and output from any and all elements of the network and the devices used by the consumer; and it regulates gateways, both commonly known and newly arising gateways, where personal information and data are collected or foreseeably likely to be used.

It is still another objective of the present invention to provide a Content Mediation Agent comprising means for identifying and managing stored personal data of a user on a device or network. Content Mediation Agents act as a distribution center for all of a consumers' photos, videos, publications, creative content, and other personal content. These Agents enable users, through intelligent settings, automated functions, and programmable user interfaces, to grant or restrict access to their content. The Agents can be controlled by a system administrator (in some cases) but more importantly by each consumer from multiple locations or points of access throughout any devices and networks on which their accounts are active, they engage in activity, or they have stored data.

### DEFINITIONS

The term “gateway” is broadly construed to comprise any software or hardware means for regulating data with respect to the ability to access, control, create, modify, filter, organize, evaluate, transform, transmit, read, write, view, copy, use and/or trade said data, for examples. Said data may comprise raw data (e.g., log data, behavioral data, navigation history, identifying data, personal information, input, output, file data), secondary or “metadata” which is data derived from inferential or predictive applications of other data (e.g., analytics data, metrics data, preference data, predictive data, profile data), information comprising communication or other transmissible content (e.g., voice data, command data, message data, network data), as well as code in software that affects such attributes of such data (e.g., program data, application data, functions, bots, protocols, plugins, downloads, executable data). A gateway comprises a selective barrier having various functions, which permits or denies a first actor in a first location to interact with data or other resources and assets in one or more additional locations. Said actor may be either a human or a mechanism such as a software application or any automated means for causing action.

“Aggregators” are used herein according to the manner known by those of ordinary skill in the art, in particular the arts of behavioral tracking, data mining, web crawling, ad serving, content providing, personal identification and profiling, and database management. An aggregator comprises a means for gathering and storing information, more particularly, for gathering information of a specified type, or having designated characteristics, from multiple sources but most commonly from web browsers and online sites, network-linked devices, server side infrastructure, and subscribers' personal computer systems. Aggregators may be software or hardware based applications and assets; and aggregators may be persons, companies, or other agents involved in compiling information (typically information about specific individuals or topics), often for the purpose of using and/or selling that information for profit.

Because there is an extensive range of information, assets, and other valuable data that may be gathered, managed, valuated, and/or traded as a product comprising an individual's personal and behavioral profile, the mention of specific examples throughout this specification is not to be construed as limiting unless otherwise indicated. For simplicity's sake, the phrase “personal data” will be used as the general term to refer to any and all types of relevant data and content generated by an individual including any information, assets, content, log data, observations, inferences, predictions, publications, metadata, search engine results, analytics data, or other valuable elements that the invention might utilize in any way as it is being described in any embodiments of the methods and systems provided and illustrated anywhere in this specification. Therefore, this phrase will be used broadly except where particular assets, content, or other useful subject mater are overtly identified and isolated. “Personal-behavioral data” will be used whenever desired to draw special emphasis to data that is generated by the behavior, rather than creative content, produced by a person.

Any embodiment of the invention may comprise a proprietary hardware device or software, or an intermediate between the two (such as an operating system or microchip), or an aggregate of many (such as a global or regional network). The terms “personal computer” and “device” are construed broadly herein to include tablets, portable computers, desktop computers, and any other means for providing internet access to a consumer, whether that consumer is an individual, a business, and organization, or other entity. The typical personal computer includes an operating system, where an operating system is defined broadly herein as understood by persons of ordinary skill in the relevant arts; for example, one common definition of “operating system is: “a collection of software that manages computer hardware resources and provides common services for computer programs.” For hardware functions such as input and output and memory allocation, an operating system typically acts as an intermediary between programs and the computer hardware. Examples of popular modern operating systems include Android, BSD, iOS, Linux, OS X, QNX, Microsoft Windows, Windows Phone, and IBM z/OS. An operating system of the present invention may be organized in various ways as understood by persons of ordinary skill in the relevant arts; for example, a Distributed operating system manages a group of independent computers and makes them appear to be a single computer, so that distributed computations are carried out on more than one machine; a Templated operating system (typically found in the cloud computing context) is a single virtual machine image applied as a guest operating system as a tool for running multiple virtual machines; and Embedded operating systems operate on small machines like PDAs with less autonomy or resources. The terms “consumer” and “user” are likewise intended broadly to mean any entity, subscriber, registered user, business, organization, or any other entity subscribing to any of the service provided by the systems of the present invention or any entity utilizing the goods and services hosted by the systems of the invention.

The applications and software of the invention may include web browsers, email and messaging services, presentation software and social network applications, digital wallets, websites or embedded applications, and any other application whereby personal data may be created, captured, identified, or stored. A software is generally a product comprising a suite of individual applications. Electronic messaging services may comprise any means for sending messages over a network such as SMS, email, text messaging, and the like. Devices of the present invention are designed, in certain preferred embodiments of the system, to convey to the eye a distinct look and feel to associate them with the concepts of openness, trust, cooperative profitability, and/or support for individual rights of privacy and personal property ownership.

Certain implementations of the invention may involve the use of a platform-specific (e.g., proprietary) digital currency, such as a cryptocurrency, as the means for monetizing the value of personal data. In particular, consumer behavior of any kind that generates personal data or user-generated content may be processed by an algorithm that converts such behavior into a “proof of work” or “proof of stake” value, or into any other mechanism for generating and maintaining a blockchain in a cryptocurrency protocol. Such protocols are understood by persons of ordinary skill in the art of cryptocurrency, which is epitomized by the bitcoin protocol and its various alternative mining schemes and related implementations. Typically, digital currencies like bitcoin are “mined” by virtue of some computer processing power or some human effort within a network, which mining activity converts digital work into data representing the value and liquidity of the currency, not only generating “coins” at a specified rate but also regulating the trading of those coins as represented by transactions stored in a decentralized ledger maintained on a peer-to-peer network. By substituting the creation of personal data for this work (e.g., mining and ledger management), the present invention can generate and sustain a digital currency platform or engine using this personal activity, thereby deriving monetary value from activity which had previously been useful only for generating data for capture and aggregation by third parties. Now, what was previously annoying and potentially detrimental to a consumer can be harnessed and used as an engine to create value directly by and for the consumer in the form of a digital currency. This optional feature of the system represents an alternative method by which the present invention provides various means for monetizing the private information and personal activity of a computer user. Any other methods for transforming the personal behavior, data, metadata, input, output, and online activity of a computer user into quantifiable value are also intended to be encompassed herein.

Additional objects, features, and advantages of the present invention will be more readily apparent from the following detailed descriptions of some preferred embodiments thereof. The present invention is not limited in its application, details, or components merely to those set forth in the following description and illustrations. The present invention resides not merely in any one of the features set forth in this specification, but also in the particular combination of all of the features and improvements claimed. Methods and devices consistent with the present invention are capable of other embodiments. In general, the order of the steps of disclosed processes may be altered within the scope of the invention. Also, the phraseology and terminology employed herein are for the purpose of description and should not be regarded as limiting unless explicitly stated as such.

### BRIEF DESCRIPTION OF THE DRAWINGS

FIG. 1 is a flow chart listing categories of personal data in a first column matched with examples of such data in a second column and potential dispositions of such data in a third column.

FIG. 2 is a flow chart listing categories of personal data in a first column, categories of applications implemented in the system of the invention in a second column (comprising two sections, a and b, on the right hand and left hand of the column, respectively), and listing a series of objects for the potential disposition of such data in a third column.

FIG. 3 is a flow chart describing an administrator's development plan for assembling a new implementation of the system of the present invention, comprising a mobile phone client device used by a subscriber of a cooperative Community that is operating the profit-sharing business model of the invention.

FIG. 4A is a schematic diagram of a first subscriber, user 1, interacting with a website through a proxy in the system of the invention.

FIG. 4B is a schematic diagram of a first advertiser interacting with the subscriber, user 1, through a proxy in the system of the invention.

FIG. 4C is a schematic diagram of a second subscriber, user 2, interacting with a website through a proxy in the system of the invention.

FIG. 4D is a schematic diagram of an advertiser interacting with the subscriber, user 2, through a proxy in the system of the invention.

FIG. 5A is a flow chart depicting the various modules of a system comprising an extensively implemented embodiment of the invention and their interactions.

FIG. 5B is a close-up view of the central panel of the flow chart of FIG. 5A.

### DETAILED DESCRIPTION OF THE DRAWINGS

“Mnopi” is a tradename (used hereinafter for lexicographical convenience) representing a preferred embodiment of the present invention that comprises (a) software, (b) services, (c) gateways, (d) aggregators, (e) shared ownership of assets and/or profits by subscribers in a business method resembling that of a mutual company, cooperative, and the like, (f) means for enabling individuals to track, organize, manage, own and commoditize personal data and other original content generated by their activities, (g) means for conducting a centralized system administration overseen by a top-level management entity that is beholden to said subscribers according to said business method, and (h) means for enabling the individualized and customizable regulation and optional features of at least some of said goods, services, gateways, and aggregators by each of said subscribers, which in preferred embodiments is at least partially controlled by subscribers through a user interface such as a graphical dashboard. Any of these elements may further comprise systems and methods for enabling the reflexive management of personal data according to the propositions that (1) an individual's personal control over the content, use, and value of his or her personal data should be maximized, (2) third parties' collection, use and/or control over said data should be made to require the informed consent of the respective individual to the greatest extent practicable, (3) property interests and other value in and of said data should be retained by and/or returned to said individual, (4) the value inherent in said data should be valuated not only by the market's criteria but also by criteria uniquely relevant to said individual, and (5) a company management entity should oversee and provide economies of scale and powerful means for accomplishing the ultimate goals desired by the subscribers across the spectrum of the internet value chain while providing goods and services focused directly towards this end.

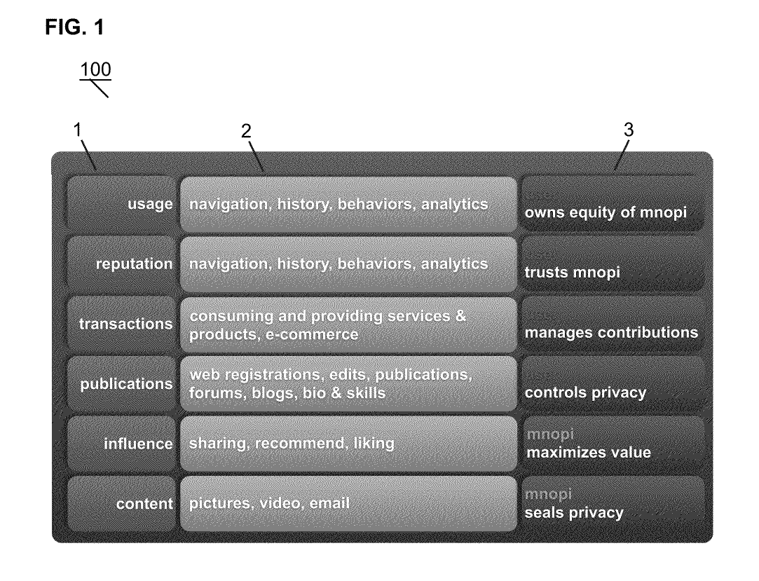

A sample overview of the mnopi embodiment of the system comprising various data types and means for managing those data is presented in the chart 100 of FIG. 1. The left hand column 1 lists five types of personal data plus a sixth type comprising original content data. The middle column 2 describes some of the constituent information associated with each of said six types of data by providing some examples in each. The right hand column 3 presents possible allocations of control between the administrator (e.g., the mnopi company) and the individual subscribers over these data.

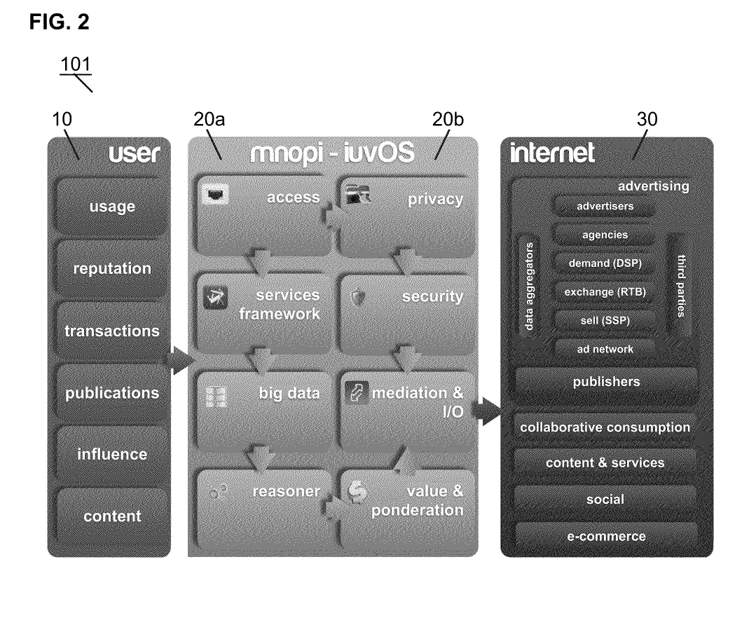

FIG. 2 is another chart 101 that illustrates examples of some means for providing software, hardware, gateways, and aggregators, and other functionality within the system of the present invention (in the middle columns 20a and 20b) and shows schematically how said means can be interposed between the activities of a subscriber (the “user”) who generates said data (said six types of which are repeated in the left column 10) and some commercial enterprises inhabiting the internet where such data is typically applied or disposed (right hand column 30). Underlying this schematic diagram is the following structure. First, a user has become a member of the mnopi cooperative and a subscriber to the mnopi system and has installed mnopi applications locally on his or her computing devices associated with activities like those in the left hand column 10 of FIG. 2. Membership in the mnopi system also brings remote applications and services to bear upon the flow of information from the subscriber to the world such as through gateways, proxies, designated mnopi servers and networks, other specialized applications, and transactionally via business relationships, licenses, and other agreements. Second, each subscriber has agreed to provide prior authorization granting the mnopi system and company ongoing access to certain data generated by said subscriber while using certain applications, receiving certain services, interacting with certain sites and businesses, or engaging other general and specific activities. In other words, the subscriber has agreed to be tracked extensively by mnopi in exchange for the subscriber's right to share ownership in the value of the resulting personal data and to exercise a variable degree of control over what kinds of general and specific content can be included or excluded from the mnopi aggregation means. The valuation and disposition of personal data and content produced by the subscriber may also be affected according to various optional parameters that can be selectively applied by the subscriber within the confines of the regime established by the mnopi administration and governance elements (preferably specified in a “terms of use” agreement).

Said personal data are created by each subscriber as he or she uses electronic devices, computers, and software applications, while interacting with others or engaging in transactions, where said personal data comprise diverse content ranging from web browsing histories to analytics, generally comprising the types of data known by persons of ordinary skill in the arts relating to behavioral tracking and data aggregation. Further data are found downstream of subscriber activity wherever a business, individual, or algorithm records, reacts to, or evaluates these data, for example when an application generates reputation data and propensity information from raw behavioral data about the subscriber. When the subscriber engages in transactions the subscriber discloses personal and financial information while revealing preferences, spending habits, lifestyle cues, interest and ownership in certain products and brands, and a range of other statistics from which commercially relevant and valuable data can be derived, particularly by advertisers and merchants. Similar personal-behavioral information is revealed in the subscriber's publications of original content, whether on informal blogs, in online communities, through formal submissions of the subscriber's creative content to various outlets, or via the subscriber's reposting or commenting about other authors' works.

Note that the above description, in contrast to the prior art, highlights the fact that a subscriber, and only a subscriber, knows the precise degree of accuracy represented by his or her data insofar as they reflect his or her true personal-behavioral characteristics, and therefore all third-party mechanisms in the prior art for harvesting these data and deriving inferences from them are comparatively incomplete, and often misleading or specious. This fact is a principal defect in the status quo of the prior art which is remedied by the present invention and which establishes an extraordinary utility of the present invention. Mnopi achieves this remarkable result by providing subscribers with means to review, correct, donate, and update elements of their personal-behavioral profile, and also to send direct comments and feedback to third party purchasers of the subscriber's personal-behavioral data. These means may comprise standardized fillable forms, email or instant messaging services and the like, via software that records keystrokes and mouse movement, via applications that report on relevant subscriber actions and commands or responses to content, or by direct communication between the subscriber and a human agent such as a customer service representative.

The systems of the present invention provides a range of tools to enable the subscriber to monitor, direct, adjust, track, and otherwise control his or her data output at its point of origin before it escapes into the public domain. Furthermore, distinct and overlapping means are provided for exerting control over some data and content even after it escapes into cyberspace, although the administrators of the mnopi system are better equipped to provide these services and oversee their operation than are individual subscribers. For example, the final two examples in the left hand column 10 of FIG. 2 are “influence” and “content,” which raise unique challenges of regulation and appropriation that require the longer reach, more sophisticated methods, greater capacity, and economies of scale that individual subscribers cannot handle but that the mnopi central administrative agency can accomplish. Published original content, for example, unlike most personal data, can be retrieved, and remains owned by its author (e.g., under copyright law), after it is released into the public domain. Both original and non-original content can reside on the web, beyond the reach of the typical individual author, but still representing the expression of said author and still generating further relevant personal data. Therefore, the mnopi system can affect said content in cyberspace through various functions such as crawlers, copyscape algorithms, search engine results, and personal communications by legal professionals demanding action from an infringer (which would be handled from within the executive management elements of the business methods of the present invention). Additionally, the mnopi system can provide redundant means for monitoring the transmission, use, and disposition of all types of data, including but not limited those examples provided in FIG. 2, in cyberspace as a second layer of regulation that operates behind or after the subscriber has decided whether and how to release his or her data and content through the member's local mnopi software residing on the user-end of the system.

Based upon this framework, an array of additional general and specific means for further regulating content and data is obtainable all the way across the internet value chain, from the immediate origin at the user-end of the chain through the intermediate realms of social networking and internet activity and out into the farthest reaches of cyberspace according to the needs, demands, and best interests of the members of a community of subscribers. These best interests comprise considerations about profitability and financial issues as well as about privacy and individual subscribers' personal concerns, and they are evaluated according to the administration's business judgment within the legal framework of said business method.

The middle column 20a and 20b of FIG. 2 represents some types of the means for regulating personal data incorporated in the mnopi embodiment of the system. Access: this element relates to means for controlling who has access to information about a subscriber's identity, behavior, and intellectual property. Access may be regulated by mnopi software applications and plug-ins which interdict where third party applications would otherwise gain access to a person's personal-behavioral data and content, such as widgets and forms prompting a user to type in a username and password in any of various websites and services, log data and system information gathered from a person's computer systems, social network data and activity, lists of friends and contacts, browser settings and navigation histories, and all other information that the person generates through his or her behavior. A Services Framework comprises a distributed assortment of specialized gateways, aggregators, or other applications specifically designed to accomplish certain functions like tracking or protecting certain types of data, data arising from the use of certain applications, data resulting from certain activities, and so on. It allows new services to be developed on top of the architecture with same principles of giving value to the user while sealing privacy. This broad category is to be contrasted with “Big Data” which symbolizes the remote and centralized mnopi administration infrastructure, which in preferred embodiments comprises a mnopi server where high-level data aggregation occurs and system-wide applications reside. The “Big Data” element further comprises a large database sufficient to store (according to the asset-sharing paradigm of the business method of the present invention) the data and content allowed by subscribers to be compiled and mined and then packaged and sold to those third parties who would otherwise have coopted these data for free or purchased them from another party that did so. While the services framework intensively regulates the transmission of personal data and content from its source with the subscriber to the outside world, the “Big Data” components of the system coordinate and regulate the operation of these various functions and accomplish other objectives that require the power and reach of server-side infrastructure.

The Reasoner comprises means for performing analytic analyses, data mining functions, inferential and predictive calculations, profile organization, and other tasks, some of which may be known in the arts of behavioral tracking, Ad serving, data trading, personal profile development, and the like. The Reasoner, in general, comprises algorithms that decide how to organize, manage, distribute and leverage subscriber data according to the objectives and requirements of the mnopi system, services, other assets, company procedures, and various strategic aims. The Privacy component comprises resources that add extra layers of privacy to the devices and applications used by subscribers and susceptible to interloping by third parties. Alternatively or in addition, privacy features of mnopi may interact directly with commercial software on a subscriber's system to access its privacy features and adjust them in response to needs perceived or required by the performance of the whole. And, other privacy applications known in the relevant arts may be bundled into any embodiments of the present invention. Having an augmented, redundant, integrated, and/or centrally controlled privacy regulation regime for each subscriber of the mnopi system strengthens its power to thwart and compete against the heavyweight industry actors in the personal-behavioral data industry. The Security component fights malicious code, spyware, viruses, and other unauthorized intrusion into systems and applications of the mnopi system and of its individual subscribers.

The Security regime can be flexibly organized analogously to the Privacy regime, for example by using proprietary techniques and tools specially designed to protect against known threats, whether those threats come from particular parties, IP addresses, products, cookies, spiders, functions within commercial software applications, and the other “tricks” of the personal-behavioral data industry that allow phishers and trollers to sneak into a consumer's computer environment to spy. For example, specialized applications comprising “data sealers” may be provided by the system to accomplish these tasks for general and specific objectives. On the one hand, illicit third party intrusions can be blocked and on the other hand, the techniques of the third party intruders can be adopted under the control and for the benefit of individual subscribers of the mnopi system. The Mediation and I/O component regulates and protects hardware against third party intrusion and monitors the flow of data across the systems and components of mnopi and its subscribers. The Mediation and I/O component negotiates with internet players to show content of the user on their sites while the content is only stored on mnopi servers. It also takes care of delivering advertising to the user or services while sealing privacy. The Mediation component will also negotiate and maximize the value of the data. The Value and Ponderation component deals with the economic performance of the system, tabulating and valuating the individual and aggregate assets of the system, making decisions to offer and sell data on behalf of the company in the marketplace, keeping ledgers, monitoring ownership, and generally serving as the virtual chief financial officer (CFO) of the system. This component is most associated with the commercial services and activities presented in the right hand column 30 of FIG. 2.

On the right-hand column 30 of FIG. 2, an assortment of prominent actors in the internet value chain or online marketplace are listed. These illustrate how the mnopi system intercedes between the user and these third party actors, as well as deals directly with them as a peer and a competitor. The particular functions of the monpi system's regulatory infrastructure are designed with the knowledge and expectation that they will interact with these third party actors, so the customary practices of the players listed in the right hand column 30 influence the design and operations of the components in the middle column 20a and 20b. The mnopi administrative entity is responsible for establishing these interfaces for the benefit of subscribers and the company. Although listed as distinct categories, all of the above-mentioned means for regulating personal-behavioral data which are incorporated in the mnopi embodiment of the system overlap and can be integrated, can crosstalk, and can work together synergistically.

Within the components of the middle column 20a and 20b, particularly in the Access and Privacy categories, are further means for enabling each subscriber to reflexively interact with his or her own personal-behavioral data. Since said data are collected by mnopi using some of the same means used in the prior art by third parties, the present invention gives subscribers the special ability to see what this hidden industry has been seeing for years in their aggregators and databases. But subscribers have an additional and stronger power to leverage and monetize their own data because they can use various features provided by the mnopi system to “proof-read” or validate their own data and profiles. In the marketplace, buyers of the data will be more confident in the versions offered by mnopi systems because it has been gathered honestly, openly, with the informed consent and active participation of the very people about whom these data pertain.

Subscribers have more than just a profit motive for ensuring the accuracy and richness of the data in their profiles, but they also benefit when they enable Ad servers, service providers, and others to know as accurately as possible how to target advertisements, content, search results, cultural and lifestyle preferences, and other individualized information to the subscriber in his or her daily web-based activities so said subscribers can experience the most comfortable and rewarding experiences in cyberspace. The system allows general and specific feedback pertaining to general and specific items such that, for example, a user who is offended by a certain type of advertisement can pass that information on to the mnopi system which will educate the third party providers about these preferences. Unlike the status quo in which third party aggregators and trackers are expected to tolerate a constant baseline level of inaccuracy in their data, mnopi achieves unprecedented quality, quantity, accuracy and richness in the personal data it collects for sale because it gives subscribers a financial interest in the sales. Furthermore, it harnesses the natural incentive that subscribers have to regulate the data being used to serve them ads and content so that the subscribers can experience the most desirable environment when they use computerized services and participate in online activity.

And still further, the mnopi system advantageously provides avenues for direct responsive feedback about content that can benefit third party providers (and which further increases the inherent value of the data mnopi sells) so that ad servers, merchants, and other content providers can rely on direct communication to refine their performance instead of remaining stuck in the status quo relying upon inferences drawn from click rates and other indirect, unreliable indicators of the effectiveness of their practices. Mnopi enables verification by direct interrogation of subscribers. Moreover, mnopi can aggregate all data generated by a subscriber from any IP address and any personal device because the subscriber has forsaken anonymity (with respect to the mnopi system only) in light of the security the subscriber gains through the presence and protections of the system. Mnopi thereby promises better quality and depth of data in the long term, having a more powerful ability to monitor, identify, and verify the daily behavior of its subscribers over an indefinite period of time, whereas the status quo requires data hunters to attempt to match IP addresses or other cues to piece together a patchwork picture of a given individual's behavioral history or “trail of breadcrumbs.”

One way to enable the selective release (and/or withholding) of personal-behavioral data according to the preferences of an individual is through contracts negotiated between second parties and subscribers, the latter being represented by the administrative and/or corporate managerial authority at the top level of the mnopi system. The executive directors of mnopi could, for example, negotiate with popular providers of digital content and services to allow mnopi to position its software in conjunction with the API or other means by which said providers interface with their customers. Such popular providers might include, for example, Facebook, Twitter, LinkedIn, Match.com, TripAdvisor, Amazon.com, and any of the countless other places where individuals might exchange information, engage in activity, publish original content, interact with third parties, create an account, undertake a transaction, or otherwise generate potentially useful personal data. The contract would enable mnopi to offer its subscribers the option to provide or withhold data in some or all of designated categories or locations, and would agree to compensate said individuals according to their use (and ultimately the value of their contributions with respect to marketable data) of said second party resources. Another means for controlling original content, especially after it has already been usurped by outside actors, may comprise integrated copyright protection functions and services, such as means for crawling the web to identify infringing use of protected content or using search-engine based routines for monitoring the migration of data outside designated web locations, and the like.

One of the economies of scale that a system of the present invention can achieve, and which others in the prior art cannot, is to monitor an individual with permission across all devices, web addresses, forums, applications, and other locations they may visit as they leave their trail of breadcrumbs along the way. Another feature of the mnopi system is the defensive and proactive means by which the Privacy modules, Data sealers, Access components, and other functional parts of the mnopi infrastructure can provide integrated, far-reaching, and sophisticated means to thwart and compete against third parties seeking to appropriate the personal and behavioral data generated by mnopi subscribers. An important duty of the mnopi administration elements is to deploy countermeasures, shields, filters, and other gateways where allowable as offensive mechanisms to prevent the successful acquisition of subscriber data by these outside unauthorized scavengers, where such mechanisms can include general and specific software applications, strategic planning by system engineers, legal and commercial activity intended to influence third party behavior, and any other means for identifying, protecting, sealing and privatizing subscriber data in response to outside attacks or intrusions, and by tracking and recovering said data in some case, and also by going after the third party application or other means executing the intrusion, such as by deploying countermeasures to confound or disable the intruder, or by identifying the ultimate source of the intrusion so that legal action can be undertaken in response.

The present invention further provides hardware and software means (of the various types previously described above) for enabling each subscriber to proactively and intelligently organize and manage his or her own personal-behavioral profile. Not only does a subscriber acquire control over outside actors' access to the relevant data as it arises from the subscriber's activity, but the subscriber also owns the data and its aggregated, analyzed, and transformed composite dataset that is produced and stored by applications and hardware within the centralized administrative component of the mnopi system, where said storage preferably occurs on the “Big Data” element represented in the middle column 20a of FIG. 2. Because mnopi also engages in the marketing activity typically associated with personal data throughout the various echelons of the internet value chain, the subscriber is incentivized via the profit-sharing opportunities of the mnopi business methods to verify, validate, elaborate, prune, and otherwise endeavor to ensure that said subscriber's profile is as valuable as it can be. The hardware and software means by which mnopi enables its subscribers to perform such reflexive interactions with said profiles may comprise, for example, a desktop or browser-based user interface application granting secure (and non-destructive) access to the subscriber's respective account, where these interactions can occur by any database management tools known in the art or suitable for the desired tasks. These tasks shall comprise means for achieving at least some of the results including but not limited to (1) maintaining desired levels of privacy in general and in specific content zones, (2) representing the true and up-to-date preferences and interests of the subscriber, (3) permitting the subscriber to eliminate or add data from and to the profile within defined bounds as delimited by the subscriber agreements and business practices of mnopi, (4) empowering the subscriber to interactively leverage the latent monetary, identifying, and experiential value in the data and content generated by said subscriber, stored in said profile over long periods of time and across a theoretically limitless range of coverage, and elaborated upon by mnopi's additional means for performing analytics and other operations for extracting higher-order data from the originally gathered data, and (5) providing means for communicating with buyers and other third parties who direct their content at the subscriber, in order to facilitate the harmonization of their efforts with the preferences of the subscriber and such that the subscriber's digital environment can conform and evolve according to the satisfaction and desires of the subscriber.

### An Example Implementation of the Mnopi Platform

In a first preferred embodiment of the present invention, they system comprises a specially-adapted cellular phone or equivalent network personal communication device and a business method for sharing revenue with each member consumer in a cooperative fashion, effectively making the users shareholders or “owners” of the system, or of a virtual cooperative entity within the system. A group of consumers sharing revenue on an implementation of the system of the invention may be called a “Community.” In related embodiments, the phone is substituted by a tablet, personal computer, electronic accessory, or other consumer electronic device having a memory means for storing or collecting personal data. One branded model of this device of the present invention is the OPI PHONE, which is a custom-configured phone that comprises applications provided according to the invention. These proprietary software programs and accessory applications range in complexity from an operating system to a user program to a simple cookie. In a fully implemented system, several programs and applications installed both on a personal device like the OPI PHONE and on remote servers of the network combine to provide a unique user experience for the benefit of the consumer using the phone, marrying intelligence and intuitive functionality.

The system also provides a user interface, preferably in the form of a “dashboard” or other control means for enabling the consumer to see and manage their user data on the device and across a network, as well as to discover its monetary value and determine how to allocate the data items and how to capture their value. Said financial value is determined in most cases according to the value it has to outside parties with a known interest in acquiring said data and even to potentially interested parties who may desire to negotiate for the purchase of said data. Negotiations and price determinations would typically be derived from market statistics and established through the back end of the system, but may be individually negotiable by the individual consumer/user in some cases. The later type of transaction involving individually negotiated monetization terms applies in most cases to unique creative content generated by the consumer, such as a slideshow, a movie, or a document. Most other types of data are personal behavioral data and metadata commonly sought by third party cookies, data aggregators, ad vendors, and other outside parties and tend to be monetized according to their respective market values. The implementation of these monetization mechanisms are preferably controlled by a proprietary engine within the network called the User Broker Engine.

Thus, each consumer utilizing the system of the present invention is informed when any of their activity generates personal data, and where that data is stored, and who is accessing or attempting to access it, and who might be interested in accessing it and why, and what monetary value it may have, and what options exist for capturing said monetary value, and how their personal data is accumulating value over time. These derived outputs are then visually displayed or otherwise represented in the dashboard. However, an administrator of a Community may decide to set predetermined rates for some types of personal data that is collected but not displayed among the command options in the dashboard (because the consumer has previously agreed that the administrator will control the disposition of these data from the back-end). Such terms are provided in the terms of use in most cases when a consumer becomes a subscriber/member of a community and agrees to the schedule of remunerations. The parties who are interested or potentially interested in purchasing said data include any entity ranging from an advertisement vendor, a data aggregator, a robot, a merchant, another consumer in the Community, an organization outside of the Community, and so on ad infinitum.

According to this method, the consumer is able from the user interface (e.g., the dashboard) to make informed decisions about how to allocate, share, sell, hide, conceal, quarantine, destroy, donate, or otherwise dispose of each personal data asset he or she generates. These personal data assets may include, for example, behavioral data of the type commonly collected by tracking cookies, or creative content wittingly or unwittingly generated by the user, such as messages, photographs, consumer activities, and so on. And, to the extent it is possible and/or desirable, the monetization of the personal data of a consumer is screened before being sold to interested parties or offered for sale, or otherwise collected and aggregated, so that personal privacy is conserved even though valuable data is transmitted out of the consumer's control. In other aspects of the invention, the consumer may be a licensee or owner of the particular iteration of the operating system they have purchased as part of the system of the invention, which then enables them to exert customized individual control over how monetization of their content is structured within the confines offered by the system of the invention as they go about using its various applications and devices.

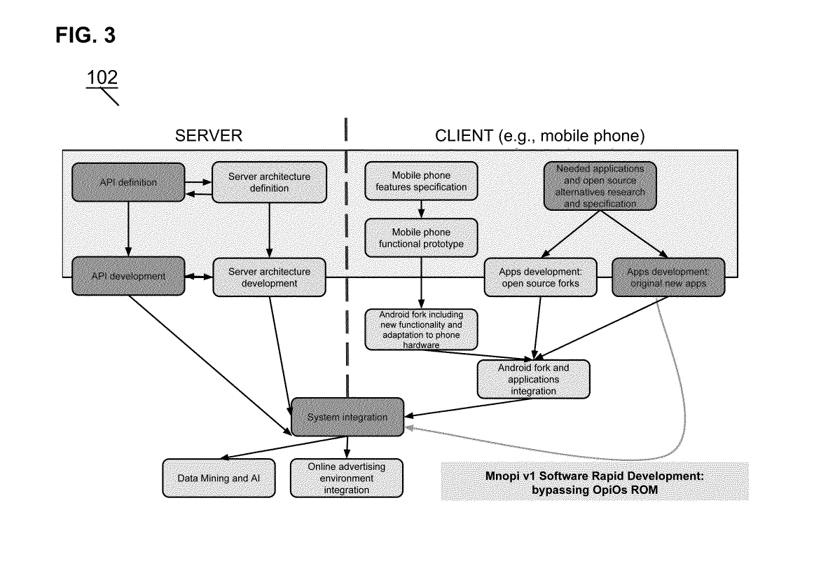

A relational diagram illustrating interactions between modules of the system of the invention and a device (e.g., a mobile phone) is given in the chart 102 of FIG. 3. A proprietary API assists in the integration of modules in the network.

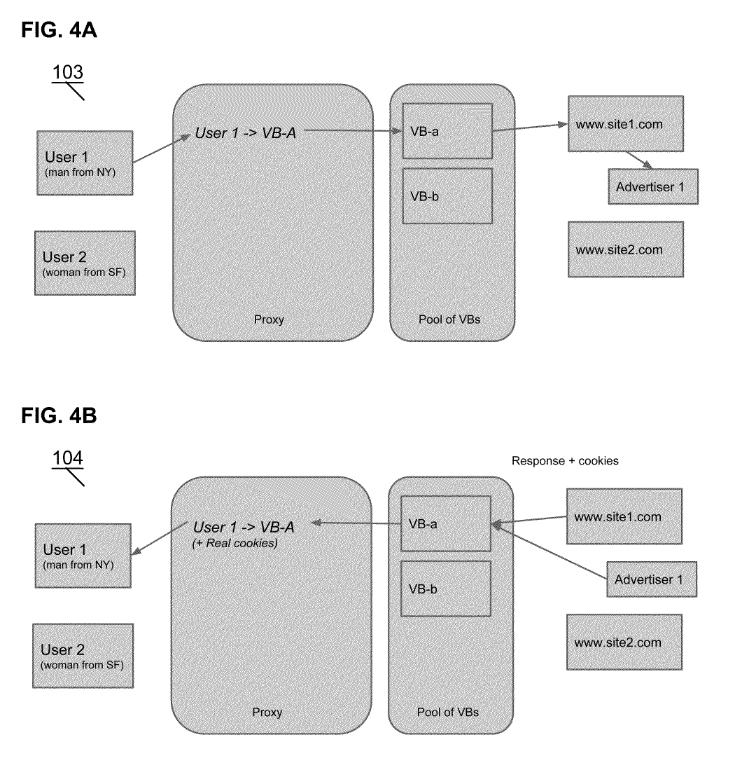

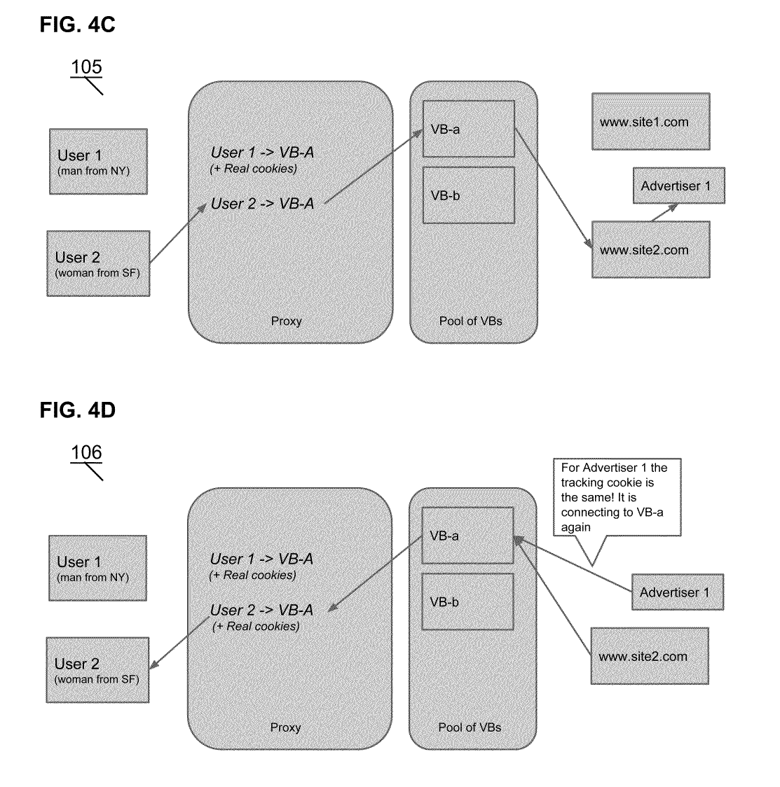

In accord with the examples diagrammed in FIGS. 4A and 4B, a cloud of servers maintains a series of Virtual Browsers (“VBs”) that encapsulate the users behind it. The proxy assigns these VBs to users dynamically and keeps track of aggregated profiles based on connections of users to the VBs. For example, FIG. 4A is a chart 103 that illustrates the action of a subscriber, “user 1,” in asking for site1.com through browser navigation. Site1.com has an agreement with Advertiser 1. The proxy saves the relation between the user and the virtual browser assigned to him, rerouting the request to this VB. The VB performs the real request to site1. Then, in according with the example diagrammed in the chart 104 of FIG. 4B, the VB receives the response, along with the cookies from site1.com and the advertiser (in the case of the advertiser, it is a tracking cookie). It redirects the response to the proxy and this to User 1. The proxy registers the cookies received. Note that in this way the Mnopi system, through the gateway of the proxy, keeps track of all the cookies received by each user.

Next, in accord with the example diagrammed in the chart 105 of FIG. 4C, User 2 requests site2.com. The Mnopi proxy assigns the user to the VB-a as well. Site2.com has an agreement with Advertiser 1 again. Then, in accord with the example diagrammed in the chart 106 of FIG. 4D, the response is given to User 2 in the same way. The Mnopi system, which keeps track of everything that has occurred, knows that it has two users with different profiles. However, for Advertiser 1 the user is the same in both cases. It will lose control of real user profiling and will think that all the users that have been routed to VB-a are the same. User experience is not affected as all the cookies are being transmitted via the proxy.

In a first implementation of a system for use in the Android environment, the Mnopi architecture is applied in both server and mobile client. In a second implementation of a system of the invention, subscribers to the Community of the system are provided with a phone that has the mnopi architecture embedded therein, particularly in a proprietary o/s (the “Opi” operating system). An example of a best mode for constructing such a network to enable the assembly of a Community of subscribers is as follows. The Mnopi Core Logger will provide application data logging to other Android apps and will send this information to the Mnopi Server. It will, inter alia: (1) Provide a service to allow other Android applications to save data in the Mnopi Core Logger database; (2) Send periodically the collected data to the Mnopi Server; (3) Allow the user to see what types of data are being saved (web pages, google searches, etc) and permit him or her to block the storage of any data at any time, to allocate that data to different uses, and to evaluate the potential monetized value of said data.

The code for conducting the above instructions can be distributed as reusable libraries. Principal features of the system include, inter alia: (1) a navigation log comprising a Page and HTML visited module, allowing the storage of webpages visited and their HTML addresses or other identifiers; (2) Search module, allowing the storage of search queries to Internet search engines. An API which provides the services needed for the Mnopi Core Logger. In this example, the Mnopi Core Logger is an Android application which will provide data logging to other Android applications and will send the data to the server. It will work for a specific user (accessed via login) and will allow the user to control what data is saved and to view the data saved. Therefore, it will act as a data console manager that has continuing back-end applicability as a tool for real-time testing and development of new and improved services to be offered on the system.

In any implementation of the above examples, the Core Logger enables new users to sign up/subscribe and subsequently to log-in. After logging in, the subscriber is operating within the Community on the network with the benefit of the proxies and gateways. At any moment, it will be possible to log out from the system and/or to stop the data collection (e.g., to exit the Community). Upon logging out, any or all stored data that has been collected while the consumer was behaving in the Community may be sent to the server. The consumers/users are able to control which data is being collected and how it is stored, shared, or otherwise disposed of. However, the administrator may decide which aspects are fully controlled by the consumer and which aspects are controlled at the administrator's discretion. In the user interface, the consumer may see a representation of the Community activity, such as in a dashboard, where it will be possible to see all the data saved at any moment in the application(s) of the system. Individual control features comprise menus and toggles which allow the starting and stopping of any and all data collection at any moment. Likewise, there are also provided means for enabling the applications to start/stop sharing or transmitting the collected data to the server at any moment. It will be possible for the user to manually send (push) collected data to the server at any moment. The programs of the system can be configured so that they execute on a per-request basis, so that when an external application launches the service, it saves the data linked to the request, stopping after the request has been processed. The service works with different types of data provided by other services. When the type of data is fixed and therefore known beforehand, the data is saved to a SQL Lite database, for example; and when the data is unstructured, the data is saved to a file, for example.

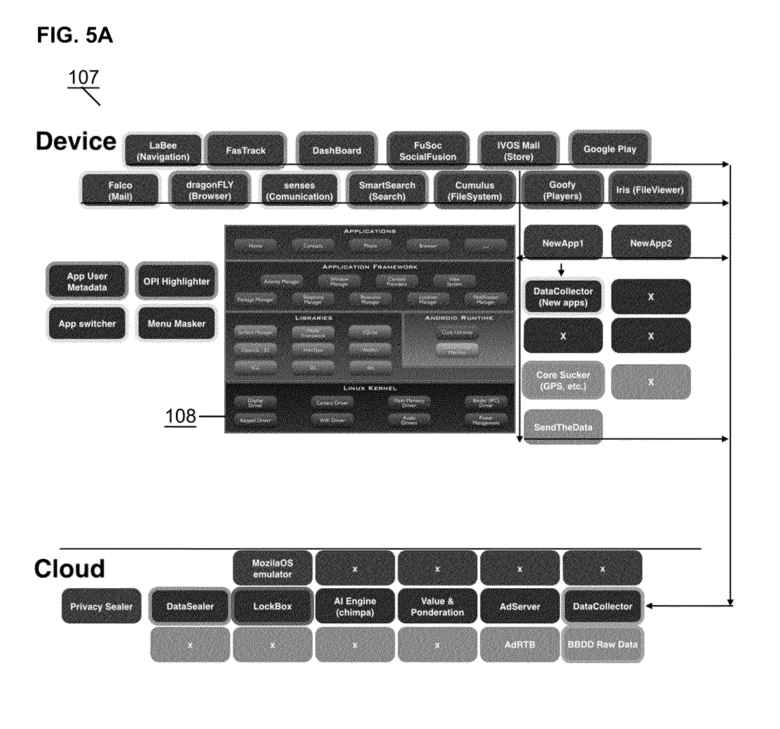

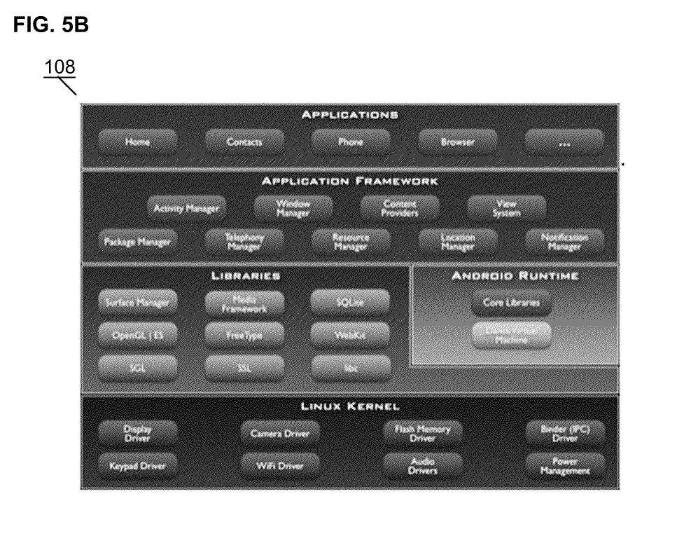

The full implementation of a mnopi system may involve, inter alia, the host of applications and services diagrammed in the chart 107 of FIG. 5A. A larger view of the central block 108 of chart 107 is provided in FIG. 5B. It should be emphasized that the above described embodiments of the present invention exemplify some, but not all, possible implementations of the present invention and have been set forth in order to provide a clear understanding of its qualities. Those skilled in the art will appreciate that the conception upon which this disclosure is based may readily be utilized as a basis for designing of other structures, methods, and systems for carrying out the several purposes of the present invention. The following claims should be regarded as encompassing equivalent and various constructions insofar as they do not depart from the spirit and scope of the methods and devices consistent with the present invention.

What is claimed is:

1. A method for providing a networked information and privacy management Service to one or more of a consumer in subscriber Community existing in a computerized network, wherein each of said consumers in the Community receives a portion of revenue generated by the Service, the method comprising:
providing the consumer with one or more proprietary software programs comprising one or more privacy gateways for operation on a personal computing device;
providing the consumer with one or more software applications comprising a plurality of personal data control features, where said control features comprise means for monitoring the input, output, computer memory locations, creation and identity of a plurality of personal data items;
tracking one or more of an activity of the consumer on the network;
determining the portion of revenue payable to the consumer;
remunerating the consumer according to a schedule of payment terms.

2. the method of claim 1, further comprising the step of providing the consumer with one or more of a personal computing device.

3. the method of claim 2, where said personal computing device comprises a telecommunications device.

4. the method of claim 3, where said telecommunications device is a phone.

5. The method of claim 1, where the network comprises both local and remote computer memory storage locations and microprocessors.

6. The method of claim 1, where at least one of said applications operates on a personal computer device regularly used by said consumer.

7. The method of claim 1, where at least one of said applications operates on a remote computing device in the network.

8. The method of claim 7, where said remote computing device comprises a server.

9. The method of claim 1, where said personal data items comprise one or more files stored in a computer memory anywhere on the network.

10. The method of claim 1, where said personal data items comprise behavioral data.

11. The method of claim 1, where said personal data items comprise metadata.

12. The method of claim 1, where at least one of said gateways regulates the input and output of data from a personal computing device used by the consumer.

13. The method of claim 1, where at least one of said gateways regulates the activity of a commercial software product that is non-proprietary to the Community.

14. The method of claim 1, where at least one of said gateways regulates the activity of a tracking cookie.

15. The method of claim 1, where at least one of said gateways regulates the activity of an advertisement service.

16. The method of claim 1, where at least one of said proprietary software programs is an operating system.

17. The method of claim 1, where at least one of said proprietary software programs is an internet browser.

18. The method of claim 1, where at least one of said proprietary software programs is an electronic messaging service.

19. The method of claim 1, where at least one of said proprietary software programs is a social forum.

20. The method of claim 1, where at least one of said proprietary software programs is a shopping marketplace.

21. The method of claim 1, where said control features further comprise a user interface, said user interface providing means for visualizing a plurality of metrics describing personal data items.

22. The method of claim 21, where said metrics comprise a monetized value of a personal data item.

23. The method of claim 21, where said user interface comprise a menu of management options, said management options representing one or more means by which the consumer may dispose of any of said personal data items.

24. The method of claim 22, where at least one of said management options relates to the selling of said personal data item to another party.

25. The method of claim 22, where at least one of said options relates to the withholding of said personal data item from another party.

26. The method of claim 1, where said schedule of payment terms relates to an equity stake in the Community which is owned by the consumer.

27. The method of claim 1, where said schedule of payment terms is based upon a performance basis relating to one or more activities performed by the consumer on the network.
